(19) United States
(12) Patent Application Publication
(10) Pub. No.: US 2008/0272182 A1
(43) Pub. Date: Nov. 6, 2008

(54) PERFORATION METHOD FOR PROTECTIVE CASINGS, APPARATUS AND FILM MATERIAL FOR SAME

(75) Inventor: Jurgen Hanten, Bad Nauheim (DE)

Correspondence Address: HAHN LOESER & PARKS, LLP, One GOJO Plaza, Suite 300, AKRON, OH, 44311-1076, US

(73) Assignee: POLY-CLIP SYSTEM GMBH & CO. KG, Frankfurt/Main (DE)

(21) Appl. No.: 12/107,830

(22) Filed: Apr. 23, 2008

(30) Foreign Application Priority Data
May 4, 2007 (DE) 10 2007 021 045.2

(51) Int. Cl. B65D 65/26; A22C 11/00

(52) U.S. Cl. 229/87.05; 452/30

(57) ABSTRACT

A method of providing a simplification for the removal of a protective casing enclosing a pasty, granular, liquid or solid filling material for forming a product in sausage or bag form, in particular in relation to sausage products, for exposing the filling material. It is further provided that at least one perforation line is introduced into the protective casing, at which line the protective casing can be torn open to pull it off.

### BACKGROUND OF THE INVENTION

The invention concerns a method of providing a simplification for the removal of a protective casing enclosing a viscous, granular, liquid or solid filling material for forming a product in sausage or bag form, in particular in relation to sausage products, for exposing the filling material.

The expression, a product in sausage or bag form, in the sense of the invention is used to denote any flexible protective casing that is filled with any liquid, viscous or pasty, granular or solid filling material and is not restricted to a given shape. It can involve a protective casing that is closed at one end, for example in the form of a bag or a bubble, or a protective casing that is closed at both ends, for example, in the form of a sausage product in the form of a ring or of an elongated generally straight shape.

Protective casings of that kind serve different purposes. Firstly, they are intended to permit transport of the filling material accommodated therein and delivery of that filling material at the location intended for same. That applies for example to chemical compositions such as adhesive or sealing materials.

If a foodstuff such as, for example, a sausage product is accommodated in the protective casing, the protective casing also serves to permit further production steps in connection with manufacture of the sausage product. Thus, for example, after the filling material formed by sausage meat has been introduced into the protective casing sausage, products are subjected to a cooking operation or a maturing process, which, for example, can involve drying in a given atmosphere. In that situation, the filling material may alter its physical condition from liquid or pasty to solid. In addition, the protective casing can serve to impart a predetermined shape to the product in sausage or bag form.

The protective casings, which are used in practice for the above-discussed purposes, depending on the respective material used for the protective casing, suffer from the disadvantage that they cannot be easily opened and pulled off without suitable aids such as a knife. In regard to small portion sausages, a smooth protective casing, mostly a smooth plastic film, is frequently used, the surface of which can be cut open only by a very sharp knife to expose the filling material, that is to say the sausage product. However a sufficiently sharp knife is often not available, or no knife at all, in various everyday situations.

Furthermore, in the industrial large-scale production of sliced sausage products, the operation of tearing open the protective casing of the sausage products plays a crucial part. This situation involves using machines that are specifically suited to the size, shape and length of the sausage and that release the protective casing from the respective sausage filling material in a very complicated and expensive process. In the case of sausage products, which vary in size, shape and length, flexibility is therefore rather guaranteed if, as is also the case with domestic use, the protective casing is notched with a knife to expose a grippable part of the protective casing, at which it is possible to begin to separate the protective casing from the sausage filling material. In order to be able to notch the often very rigid and smooth plastic casing material, a high pressure with a sharp knife is required. That mostly has the result that the blade of the knife not only penetrates the protective casing but also cuts more deeply into the sausage filling material. It is precisely in the case of sliced sausage products packaged in transparent film that such notching in the sausage material represents a visual defect.

U.S. Pat. No. 3,528,601 proposes a method in which a tear-open strip is applied to the surface of the protective casing in the peripheral direction of the sausage product. A strip that is to be externally applied is admittedly simple to fix at any spacings along the endless protective casing. In that case however, irrespective of the precise location at which the tear-open strip is applied, there is the danger that only a part of the protective casing is removed by tearing open the strip. The remaining residue then has to be laboriously removed from the filling material to completely expose it by means for example of a knife. Applying a tear-open strip of that kind therefore signifies increased production complication and expenditure for the protective casing as well as increased susceptibility to error and thus a reduction in the production speed. Furthermore, a strip applied to the surface of the protective casing can suffer damage when being transported, it can possibly tear off or it can prematurely tear open the protective casing, which finally results in the filling material being ruined.

Finally, such a tear-open strip can only be used in relation to single-layer film material. With multi-layer material, there is the danger that, when tearing open the protective casing by means of the tear-open strip, only the uppermost layer of the multi-layer film material is released.

### SUMMARY OF THE INVENTION

An object of the present invention is to propose a method of providing a simplification for the removal of protective casings from products in sausage or bag form, in particular in relation to sausage products, which makes it possible to open and remove the protective casing without further aids in order thereby to expose the filling material. A further object of the invention is to provide an apparatus suitable for that purpose and a film material.

Introducing at least one perforation line into the protective casing, at which the protective casing can be torn open to pull it off, easily provides a possible way in which the protective casing can be removed to expose the filling material. No aids or other devices are required for that purpose so that the protective casing can be removed at any location and at any desired moment in time. In that respect, the perforation line forms small desired-rupture locations in the form of the perforation holes, along which the protective casing can be torn open.

The at least one perforation line can be introduced into the protective casing of the product in sausage or bag form, in any orientation. Thus, it is possible that the at least one perforation line is introduced into the protective casing at least approximately parallel to the longitudinal central axis of the product in sausage or bag form at least over a portion thereof. The perforation line can extend only over one or more mutually spaced portions of the protective casing in parallel relationship with the longitudinal central axis. As the material for the protective casing is generally plastic material, which has a certain degree of stiffness, a short perforation line already ensures that the protective casing further tears open at the end thereof along the pulling direction and exposes the filling material. Very reliable removal of the protective casing can be achieved in that the at least one perforation line, which extends at least approximately parallel to the longitudinal central axis of the product in sausage or bag form, is introduced at least approximately over the overall axial length of the protective casing.

Besides the perforation line being arranged at least approximately parallel to the longitudinal central axis of the product in sausage or bag form the at least one perforation line can be introduced into the protective casing transversely with respect to the longitudinal central axis of the product in sausage or bag form. In that case, the perforation line can extend at an angle of at least approximately 90° relative to the longitudinal central axis of the product in sausage or bag form in the peripheral direction of the protective casing or at an angle differing therefrom.

In the case of the perforation line extending substantially perpendicularly to the longitudinal central axis of the product in sausage or bag form, it is advantageous if the at least one perforation line extending at least approximately perpendicularly to the longitudinal central axis of the product in sausage or bag form is introduced at least approximately over the entire periphery of the protective casing. That can be advantageous in particular for smaller products in sausage or bag form, which are to be exposed only in portion-wise manner, for immediate use. Thus, if the perforation line is in the upper third of the sausage, the protective casing of just that portion can be removed, and possibly, if consumption extending therebeyond is desired, further filling material can be pushed through the protective casing in the direction of the exposed end by pressing on the filling material from the end that is still closed of the product in sausage or bag form. That therefore guarantees that the part that remains in the protective casing and which is not to be consumed immediately does not come into contact with the fingers or over a large area with the ambient atmosphere, thereby preventing the transfer of germs, which can lead to the filling material being ruined.

If the perforation line extends at an acute angle relative to the longitudinal central axis of the product in sausage or bag form the perforation line can also be introduced for example in a spiral form along the periphery of the product in sausage or bag form, in portion-wise manner or completely. That affords the possibility of causing the protective casing to burst open by a slight rotation in mutually opposite relationship at a location of the surface of the protective casing, thereby exposing the complete filling material.

If, in that case, the perforation line extends from one end of the product in sausage or bag form to the other, the product in sausage or bag form can also be completely exposed without cutting off the ends.

Particularly easy and in particular complete removal of the protective casing can be achieved if at least two perforation lines are introduced into the protective casing. In that case, the two perforation lines can be introduced into the protective casing extending in at least approximately mutually parallel relationship. If the spacing of the at least two perforation lines is a multiple smaller than the cross-section of the product in sausage or bag form, then firstly a strip of the protective casing can be removed, and then the rest of the protective casing. In principle however, it is also possible if the two perforation lines are introduced into the protective casing extending at an angle relative to each other to provide that the protective casing is pulled open like a zipper.

The at least one perforation line can be introduced into the protective casing both prior to and also after at least one further processing step following the filling operation on the product in sausage or bag form. If the filling material is sausage meat, the further processing step can be a cooking or maturing process. If the at least one perforation line is introduced directly after filling of the protective casing and prior to the cooking process, the risk of bursting due to puncturing the chock-full protective casing is averted. In that respect a further advantage is afforded, irrespective of the filling material and the nature of the further processing step, if the products in sausage or bag form can be arranged in a row on a conveyor apparatus directly after the filling operation and/or another processing step such as a cooking process so that they can be easily fed to a further preparation station, that is to say a perforation unit.

If the at least one perforation line is to be introduced into the protective casing only after the further processing step, for example, the cooking or maturing process, the cooked and matured sausages first have to be passed again from the cooking compartment to a suitable perforation machine. That takes both time and also a considerable amount of machine complication and expenditure. Nonetheless, it may be preferable for the perforation line to be introduced into the protective casing after the further processing step, for example, the cooking or maturing process when dealing with sausage products. The advantage can be that the perforation holes can be more easily applied to a taut protective casing than to a still yielding protective casing due to a filling material which has not yet been structured. Preferably, therefore the perforation line is introduced after the further processing step, for example, the cooking or maturing process, preferably after the finished product in sausage or bag form has cooled down, if there is no longer to be any concern of bursting of the protective casing when the perforation line is applied.

In the case of introducing the at least one perforation line into the protective casing after the removal of at least one end of the product in sausage or bag form, such as the sausage tip in the case of a sausage product, the perforated end that is to be gripped is exposed at the surface of the sausage whereby handling is made simpler when tearing into and removing the protective casing.

To ensure that the protective casing can be easily torn open along the perforation line or lines, the spacing between the holes must be carefully selected. In the case of an excessively short spacing, the perforation line can suffer from being prematurely torn open, particularly under the effect of a pressure from the outside, and that can lead to unwanted premature ruin of the sausage product. If the spacing of the perforation holes is excessively great, easy clean tearing along the predetermined direction is often not possible or is possible only when a considerable pulling force is applied. The spacing between the perforation holes is at an optimum when the sausage casing can be torn open only by pulling at the desired end. A preferred range for the spacing can be between 0.3 mm and 5 mm.

Like the spacing between the perforation holes, the size thereof is also of crucial significance. The perforation holes must be so small that the filling material is not exposed through the holes or can issue therethrough and does not leave behind any visible traces in the sausage. That is of crucial significance on the one hand in regard to the perishability of the products in sausage or bag form. On the other hand however, this is also in the case where the perforation line or lines is or are applied after the filling operation and still prior to a further processing step, for example, a cooking or maturing process in relation to sausage products. More specifically, it is necessary to ensure that no filling material can issue from the perforation holes so that the product in sausage or bag form retains its desired properties. On the other hand however, it is necessary to ensure that the protective casing can be easily and reliably torn open along the line, by virtue of a certain size for the perforation holes. Depending on the respective filling material and preparation or time of perforation, the size of the perforation holes to be applied must be suitably adapted.

In particular, there is proposed an apparatus for the production of a product in sausage or bag form accommodating a viscous or pasty, granular or liquid filling material, in particular sausage products, wherein the filling material is enclosed by a protective casing and wherein the apparatus includes: a filling pipe through which the filling material can be supplied, a supply of the protective casing that is arranged on the filling pipe and a closure and severing device arranged downstream of the mouth opening of the filling pipe for applying closure elements to the protective casing and for severing the protective casing of a finished product from the supply of protective casing. It is further provided that downstream of the closure and severing device is a device for introducing at least one perforation line into the protective casing of the finished product in accordance with the above-described method for providing a simplification for the removal of the protective casing. In that case, the perforation device can directly adjoin the production apparatus or there can be provided one or more further processing devices such as for example a cooking device in the case of sausage products, which the perforation device follows.

If the protective casing is first put into a tubular form in the apparatus for the production of the products in sausage or bag form, there is also the possibility of the perforation device being arranged upstream of the closure and severing device or upstream of the filling pipe.

All current perforation devices can be used as the device for applying a perforation line. By way of example, it is possible for the filled products in sausage or bag form to be passed on a conveyor belt under a rotating wheel with spaced needles or small blade tips which then perforate the protective casing. One type of perforation machine or another can be preferred depending on the respective configuration of the perforation hole size and the spacing between the perforation holes. Besides those ‘mechanical’ perforation devices, there is also the possibility of providing a laser perforation unit. There, the perforation holes are produced by means of a laser beam of suitable size. That procedure is advantageous as mechanical stressing of the film material is avoided.

As already stated hereinbefore, a preferred configuration of the method according to the invention provides that the at least one perforation line is introduced after a further processing step that follows the filling operation. In general terms, it can be said that the operation of introducing the perforation line can follow at the end of the procedure for the production of the product in sausage or bag form. When the perforation line has been introduced into the protective casing in particular in that case, but also in any other case, the protective casing can be broken open along the perforation line and can be pulled off the filling material of the product in sausage or bag form for example by hand.

Equally however, it is also possible to use an apparatus specifically provided for that purpose. That apparatus has at least means for breaking open the protective casing along the at least one perforation line, means for grasping the edges and/or corners of the protective casing, which project by the protective casing being broken open along the perforation line and also means for uniformly pulling off the protective casing which is grasped in that way.

The means for breaking open the protective casing along the perforation line can be of different configurations in that respect. Thus there is on the one hand the possibility that this involves a runner wheel that at its outside peripheral surface has an edge that converges to a point but is not sharp-edged in the pointed region. In other words, that runner wheel is of a triangular cross-section with a radially outwardly pointing triangular point. There is equally the possibility that means for breaking open the protective casing along the perforation line are formed by an elongate opening element of a wedge-shaped configuration. What is common to both cases is that the protective casing can be broken open along the perforation line thereby, but damage to the filling material, whether it is in granular, pasty, liquid or solid form, is avoided.

The means for grasping the corners or longitudinal edges of the protective casing, which project outwardly along the broken-open perforation line, can be small gripping elements, which are displaceable in the longitudinal direction of the product in sausage or bag form by means of a hydraulic arrangement, which can then form the means for pulling off the protective casing. In that case, the gripping elements can be moved reversibly into a closure position or an open position in order to eject the protective casing that has been pulled off, over a receiving container. Alternatively or additionally, it can be provided that there is no separate operation of breaking open the protective casing along the perforation line. Rather, the protective casing is pulled off at the same time as the operation of breaking it open along the perforation line. Advantageously for that purpose the protective casing is made graspable at a location, for example by cutting off an end of the sausage or by breaking open the protective casing over a few perforation holes.

It will be appreciated that the device for introducing the perforation holes and the device for breaking open the protective casing along the perforation line and for pulling off the protective casing can be combined in one machine unit. In that case the product in sausage or bag form is introduced into that machine unit by means of conveyor belts, conveyor chains and so forth, fixed in a position with suitable known means, then the at least one perforation line is introduced into the protective casing by the perforation device and then the protective casing is broken open along the perforation line and pulled off the filling material. As already mentioned that is particularly advantageous if the product in sausage or bag form is finished, particularly in the case of sausage products whose original granular to viscous or liquid filling material has become solid due to one or more further processing operations.

In particular, there is proposed a film material for use as a protective casing enclosing a pasty, granular or liquid or viscous filling material for forming a product in sausage or bag form, wherein at least one perforation line is introduced into the protective casing. The at least one perforation line can already be introduced by means of suitable perforation devices as are already known, in production of the film which is not limited in terms of its composition and which can be selected as respectively desired. As in a process similar to that described hereinbefore, film materials which are pre-perforated in that way can be shaped to form protective casings and finally also filled with filling material.

An advantage of a film material produced in that way is that, particularly in the case of perforation lines that later extend along the longitudinal central axis of the product in sausage or bag form, such a film material can be used for any size, shape and configuration of a product in sausage or bag form without the perforation machines having to be set to the type of product. Flexibility for producing sausage products of differing shapes is thus retained.

Here too at least two perforation lines can be introduced into the protective casing.

In that respect the perforation holes applied to the film material should preferably be of a diameter of between about 0.01 and 3 mm. In order to avoid the above-mentioned disadvantage of filling material escaping or the protective casing being prematurely torn a perforation hole size of larger than 3 mm is only restrictedly preferred.

### DESCRIPTION OF THE DRAWINGS

Further advantageous configurations and an embodiment by way of example are described hereinafter with reference to the accompanying drawings. In this connection it is to be noted that the terms ‘left’, ‘right’, ‘top’ and ‘bottom’ used in the description of the specific embodiment refer to the drawings in an orientation with references and Figure legends being normally readable. In the drawings:

FIG. 1 is a diagrammatic view of a production line for sausage products as an example of an apparatus for the production of products in sausage or bag form, using a device according to the invention for producing a perforation line,

FIG. 2 shows a view of a product in sausage or bag form with perforation lines extending parallel to the longitudinal central axis of the product, and

FIG. 3 shows a view of a product in sausage or bag form with a perforation line extending in a spiral configuration at the periphery of the product.

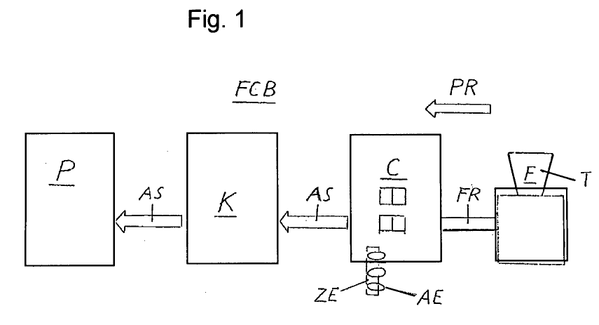

FIG. 1 is a diagrammatic view of a production line FCB for sausage products as an example of an apparatus for the production of products in sausage or bag form, in regard to the structure in principle thereof. That structure is described hereinafter in terms of its basic structures.

### DETAILED DESCRIPTION OF THE DRAWINGS

The production line FCB serves for the production of sausage products (not shown in greater detail). It will be appreciated that the production line FCB can be used for the production of other products in sausage form, such as for example sealing materials which are portioned in sausage form, and the like. In general the production line FCB can be used for processing any filling material capable of flow, that is to say therefore also granular material, fluids and so forth, which can be introduced into a protective casing material and put into portions as a product in sausage form.

As can be seen from FIG. 1 the production line FCB comprises a filling machine F, a clipping machine C, a cooking unit K and a perforation device P, which are arranged in succession in accordance with their function in that sequence which corresponds to the production process direction PR of the production line FCB. In that case, from the filling machine F, a filling material which is supplied there by way of a filling hopper T, in this case sausage meat, is fed continuously or discontinuously to the clipping machine C by means of a suitable conveyor device such as for example a conveyor pump. In the clipping machine C, the sausage meat is introduced into a protective casing material (also not shown in greater detail in FIG. 1) and put into portions to afford individual sausage products. Then, the sausage product produced in that way is discharged from the clipping machine C by way of a first discharge section AS of the clipping machine to the cooking unit K. The sausage product is cooked in the cooking unit K, where the originally pasty filling material sets. The sausage product, which is now finished, is discharged to the perforation device P along a further second discharge section AS. Still further devices (not shown) for further processing steps on the sausage product can follow along the first and/or the second discharge sections AS. It is also possible for still further devices for supplemental processing steps for the sausage products to follow in the production process direction PR.

The clipping machine C has a filling pipe FR for feeding the filling material from the filling machine F and is connected to the filling machine F by way thereof. In that case the filling pipe FR can also serve as a storage means for the supply of protective casing material which is processed in the clipping machine C. In addition the clipping machine C has a feed device ZE, preferably formed by a conveyor belt, for flexible suspension elements AE. In that case, the suspension elements AE, which are preferably formed by thread loops, lie on a carrier belt that is coated on one side with an adhesive and from which they are individually pulled off in the clipping machine C by a female die (not shown) of a clip fitting and clip closure tool. As can be seen from FIG. 1, the feed device ZE for the suspension elements AE is arranged at the clipping machine C in the region of the clip fitting and clip closure tools in such a way that the conveyor direction thereof extends at least approximately perpendicular to the production process direction PR in the production line FCB according to the invention.

In the clipping machine C, the protective casing material in tubular form is filled with the sausage meat and put into portions to form sausage products in known manner by fitting and closing clips at appropriate locations. In that case, a flexible suspension element AE is fixed at the same time at one end of each product in sausage form, the suspension element being introduced into the clip fitting and clip closure tool of the clipping machine C by the feed device ZE. The sausage product is then discharged from the clipping machine C on the first discharge section AS. In that case, the first discharge section AS of the clipping machine ends at the cooking unit K. After the cooking operation, the sausage product, which is now finished, is fed to the perforation device P by way of the second discharge section AS.

It is also to be noted that, besides the above-described procedure for fitting a suspension element AE to each sausage product, there is also the possibility of fitting a suspension element AE to each second, third and so forth sausage product, in which case then the protection casing material is not severed between the first, second, third and so forth sausage product. That results in the formation of pairs or chains of sausage products.

In the production process direction PR of the production line FCB, the clipping machine C and the cooking unit K are followed by the perforation device P for introducing at least one perforation line into the sausage product. That device is arranged downstream of the clip fitting and clip closure tools in the production process direction PR. That device P is shown only diagrammatically by a rectangle in FIG. 1. The most widely varying solutions can be provided for that. Thus it is possible for example for the device to have one or more rotating wheels with spaced needles or small blade tips, beneath which the sausage products are passed through by means for example of a conveyor belt. The number of wheels in that case can depend on the number of perforation lines. Equally the device can have a rotary turret head in which a plurality of wheels are arranged on the turret head in differing numbers and of a differing configuration so that, depending on the respective product to be perforated, it is possible to produce different perforation patterns or different perforation holes at different perforation hole spacings. There is equally the possibility of the device being formed by the row of needles that extends substantially parallel to the longitudinal central axis of the sausage product. It will be appreciated that here too, it is possible for a plurality of rows of needles to be arranged in parallel juxtaposed relationship or in a direction transversely with respect to the conveying direction of the sausage products. Finally, the perforation device P can also be formed by a laser perforation device.

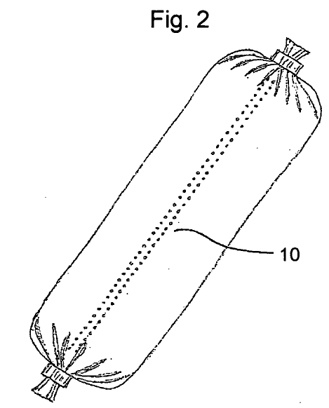

FIG. 2 shows an embodiment of a product in sausage or bag form in which a perforation line 10 according to the invention is introduced thereinto. That product is a sausage product in which two perforation lines 10 are produced extending parallel to each other substantially parallel to the longitudinal central axis of the sausage product. In this respect, as can be readily seen from FIG. 2, the spacing between the two perforation lines 10 is very much smaller than the periphery of the sausage product. As can also be seen from FIG. 2, the perforation lines 10 extend to just before the ends of the sausage product so that, after they are cut off, the beginning of the perforation lines 10 and in particular the strip, which is delimited by the two perforation lines, can be grasped and pulled off the sausage product.

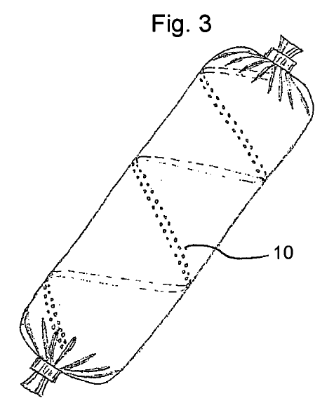

FIG. 3 shows a further example of a sausage product with a double perforation line 10, in which case the double perforation line 10 extends in a spiral along the periphery of the sausage product. The operation of applying such a double perforation line can be effected for example by the sausage product being uniformly rotated while being advanced along a conveyor belt.

A device for pulling off or detaching the protective casing can be provided at the perforation device P. It will be appreciated that such a device can also be an integral component part of the perforation device P. In that respect, as has already been described hereinbefore, after the introduction of the perforation line or lines into the product in sausage or bag form, the protective casing of that product is broken open along the perforation line. Then due to the protective casing being opened along the perforation line or lines, the outwardly openly projecting edges or corners of the protective casing are gripped by further means and pulled off by a preferably linear displacement movement of those gripping means along the longitudinal axis of the product in sausage or bag form. If the at least one perforation line is applied in a spiral to the product in sausage or bag form, the step of breaking open the protective casing along the at least one perforation line and the step of pulling off the protective casing that has opened in that way from the filling material can be effected either by spiral rotation of the opening tool or the gripping tool or however by rotation of the product in sausage or bag form with simultaneous linear displacement of the gripping tools. Finally, means for cutting off at least one end of the product in sausage or bag form can additionally or alternatively be provided in such a device, in order in that way to grip the edge of the protective casing facing in the direction of the cut-off end of the product in sausage or bag form (this is the end edge) immediately adjacent to the at least one perforation line and to break open the protective casing by the gripped corners along the at least one perforation line and in so doing at the same time to pull the protective casing off the filling material, whether it is pasty, granular, liquid or solid. Finally a device of that kind also has a storage capability for protective casings which have been pulled off.

In regard to the size and the spacing of the perforation holes relative to each other it is also to be noted that they can be of a diameter of between about 0.01 and 3 mm. The spacing of the perforation holes relative to each other should be between 0.3 mm and 5 mm.

1. A method of providing a simplification for the removal of the protective casing enclosing a filling material for forming a product in sausage or bag form for exposing the filling material, comprising the steps:
introducing the filling material into the protective casing;
closing the protective casing;
separating the finished product in sausage or bag form from the rest of the supply of protective casing,
after closure of the protective casing and separation of the finished product in sausage or bag form from the rest of the supply of protective casing introducing at least one perforation line into the protective casing, at which line the protective casing can be torn open to pull it off.

2. The method of claim 1 where the step of introducing the at least one perforation line into the protective casing comprises introducing the at least one perforation line at least approximately parallel to the longitudinal central axis of the product in sausage or bag form at least over a portion thereof.

3. The method of claim 2 where the step of introducing the at least one perforation line which extends at least approximately parallel to the longitudinal central axis of the product in sausage or bag form comprises introducing the at least one perforation line at least approximately over the overall axial length of the protective casing.

4. The method of claim 1 where the step of introducing the at least one perforation line comprises introducing the at least one perforation line into the protective casing transversely with respect to the longitudinal central axis of the product in sausage or bag form.

5. The method of claim 4 where the step of introducing the at least one perforation line extending at least approximately perpendicularly to the longitudinal central axis of the product in sausage or bag form comprises introducing the at least one perforation line at least approximately over the entire periphery of the protective casing.

6. The method of claim 1 where the step of introducing the at least one perforation line comprises introducing at least two perforation lines into the protective casing.

7. The method of claim 6 where the step of introducing the at least two perforation lines into the protective casing comprises extending the at least two perforation lines in at least approximately mutually parallel relationship.

8. The method of claim 7 where the step of introducing the at least two perforation lines into the protective casing comprises spacing the at least two perforation lines a multiple smaller than the cross-section of the product in sausage or bag form.

9. The method of claim 6 where the step of introducing the at least two perforation lines into the protective casing comprises extending the at least two perforation lines at an angle relative to each other.

10. The method of claim 1 where prior to the step of introducing the at least one perforation line at least one further processing step is performed.

11. The method of claim 1 where the step of introducing the at least one perforation line comprises introducing at least one perforation line into the protective casing after the removal of at least one end of the product in sausage or bag form.

12. The method of claim 1 where the step of introducing the at least one perforation line comprises introducing perforation holes of the protective casing having a diameter of between about 0.01 and 3 mm.

13. An apparatus for the production of a product in sausage or bag form accommodating a filling material where the filling material is enclosed by a protective casing, the apparatus comprising:
a filling pipe through which the filling material can be supplied;
a supply of the protective casing arranged on the filling pipe;
a closure and severing device arranged downstream of a mouth opening of the filling pipe capable of applying at least one closure element to the protective casing and severing the protective casing of a finished product from the supply of protective casing; and
a device, arranged downstream of the closure and severing device, the device introducing at least one perforation line into the protective casing of the finished product in accordance with the method of claim 1.

14. A film material for use with the method of claim 1 where the film material is used to form the protective casing enclosing a filling material for forming a product in sausage or bag form.

15. The film material of claim 14 where at least two perforation lines are introduced into the protective casing.

16. The film material of claim 14 where the perforation holes of the protective casing are of a diameter of between about 0.01 and 3 mm.
